(19) United States
(12) Patent Application Publication
(10) Pub. No.: US 2026/0369241 A1
(43) Pub. Date: Nov. 19, 2026

(54) HEATING CONTROL METHOD FOR DISPLAY PANEL AND DISPLAY SYSTEM

(71) Applicant: Novatek Microelectronics Corp., Hsinchu (CN)

(72) Inventor: Wu Wei Lin, Taoyuan (CN)

(21) Appl. No.: 19/434,643

(22) Filed: Dec. 29, 2025

Related U.S. Application Data
(60) Provisional application No. 63/804,695, filed on May 13, 2025.

(30) Foreign Application Priority Data
Sep. 16, 2025 (CN) 202511319347.7

(51) Int. Cl. G09G 3/36

(52) U.S. Cl. CPC G09G 3/36; G09G 2310/08; G09G 2320/041; G09G 2354/00

(57) ABSTRACT

A heating control method for a display panel and a display system are provided. The display panel includes a heater for performing a heating operation. The heating control method for a display panel includes controlling, by the touch and display driving integrated circuit, a heater driving circuit to apply a first signal to the heater to perform the heating operation in the display period of the display panel, wherein the first signal has a fixed potential corresponding to the heating operation. The heating control method further includes controlling, by the touch and display driving integrated circuit, the heater driving circuit to apply a second signal to the heater in the touch period of the display panel to perform a loading free driving operation, wherein the second signal has at least one of the same waveform, frequency and phase as a touch driving signal of the display panel.

### CROSS REFERENCE TO RELATED APPLICATIONS

The present disclosure claims the benefit of U.S. Provisional Application No. 63/804,695 filed on May 13, 2025 and Chinese Patent Application No. 202511319347.7 filed on Sep. 16, 2025, the contents of which are incorporated into the present disclosure by reference in its entirety.

### TECHNICAL FIELD

The present disclosure relates to a field of display technologies, and more particularly, to a heating control method for a display panel and a display system.

### BACKGROUND

In the field of display technologies, liquid crystal display (LCD) is widely used in various electronic products due to its thinness, low power consumption and other advantages. However, when the LCD is used in a low-temperature environment, for example, as a display in a vehicle, the response speed of the liquid crystal material will be significantly reduced, thereby affecting the response performance and display effect of the display. Usually a heater can be provided below the display panel to maintain the display panel operating at a preferred temperature. However, this architecture will significantly increase the overall thickness of an LCD display system. In addition, although attempts can be made to integrate the heater inside the display panel to reduce the system thickness, this approach may form parasitic capacitance between the heater and the internal wiring of the display panel, thereby affecting display or touch performance.

In addition, when heating the display panel, it is desirable to effectively control the heating operation of the heater so that the temperature of the display panel can gradually stabilize in a desired temperature range and avoid damage due to overheating.

Therefore, a technical solution that can effectively heat the display panel, reduce the impact of system thickness and parasitic capacitance caused by the heater, and achieve better heating control is needed.

### SUMMARY

Accordingly, the present disclosure provides a heating control method for a display panel and a display system.

According to one aspect of the present disclosure, there is provided a heating control method for a display panel, where the display panel includes a heater for performing a heating operation, and a display period and a touch period of the display panel do not overlap with each other, the method being performed by a touch and display driving integrated circuit, comprising: controlling, by the touch and display driving integrated circuit, a heater driving circuit to apply a first signal to the heater to perform the heating operation in the display period of the display panel, where the first signal has a fixed potential corresponding to the heating operation; and, controlling, by the touch and display driving integrated circuit, the heater driving circuit to apply a second signal to the heater in the touch period of the display panel to perform a loading free driving operation, where the second signal has at least one of the same waveform, frequency and phase as a touch driving signal of the display panel.

According to another aspect of the present disclosure, there is provided a heating control method for a display panel, where the display panel includes a heater for performing a heating operation, and a display period and a touch period of the display panel do not overlap with each other, the method being performed by a touch and display driving integrated circuit, comprising: controlling, by the touch and display driving integrated circuit, a heater driving circuit to apply a first signal to the heater in the display period of the display panel to perform the heating operation, where the first signal has a first duty cycle, and the first duty cycle represents a ratio of a duration of applying the first signal in a single display period to a duration of the single display period; and, adjusting, by the touch and display driving integrated circuit, the first duty cycle of the first signal during performing the heating operation.

According to another aspect of the present disclosure, there is provided a heating control method for a display panel, where the display panel includes a heater for performing a heating operation, and a display period and a touch period of the display panel do not overlap with each other, the method being performed by a touch and display driving integrated circuit, comprising: controlling, by the touch and display driving integrated circuit, a heater driving circuit to apply a first signal to the heater in the display period of the display panel to perform the heating operation, where the first signal has a second duty cycle, and the second duty cycle represents a ratio of a number of display periods in a set of consecutive display periods in which the first signal is applied to a total number of display periods in the set of consecutive display periods; and, adjusting, by the touch and display driving integrated circuit, the second duty cycle of the first signal during performing the heating operation.

According to another aspect of the present disclosure, there is provided a display system including: a display panel; a heater in the display panel for performing a heating operation; a heater driving circuit; and a touch and display driving integrated circuit configured to perform the method according to any one of the above.

In order to make the above features and advantages of the present disclosure more obvious and understandable, embodiments are listed below and described in detail with reference to the drawings.

### BRIEF DESCRIPTION OF THE DRAWINGS

The drawings are provided to provide a further understanding of the embodiments of the present disclosure, constitute a part of the specification, and serve to explain the present disclosure together with the embodiments of the present disclosure, but do not constitute limitations of the present disclosure. In the drawings, the same reference numeral generally represents the same part or step.

FIG. 1 shows a simplified schematic diagram of a liquid crystal display (LCD) display system 100.

FIG. 2 shows an example of a heater driving circuit 21 and a signal timing diagram 22 according to an embodiment of the present disclosure.

FIG. 3 shows a heating control method 300 for a display panel according to an embodiment of the present disclosure.

FIG. 4 shows a display panel temperature-time example 400 of a heating control method for a display panel according to an embodiment of the present disclosure.

FIG. 5 shows a heating control method 500 for a display panel according to an embodiment of the present disclosure.

FIG. 6 shows an adjustment example 601 of a first duty cycle of a first signal and a corresponding display panel temperature-time example 602 according to an embodiment of the present disclosure.

FIG. 7 shows a heating control method 700 for a display panel according to an embodiment of the present disclosure.

FIG. 8 shows an adjustment example 801 of a second duty cycle of a first signal and a corresponding display panel temperature-time example 802 according to an embodiment of the present disclosure.

### DETAILED DESCRIPTION

In the following, the implementation of the present disclosure will be described in detail with the drawings and examples, to fully understand and implement the implementation process of the present disclosure to solve the technical problem and achieve the technical effect by using technical means. It should be noted that as long as there is no conflict, various embodiments in the present disclosure and various features in each embodiment can be combined with each other, and the formed technical scheme is within the protection scope of the present disclosure.

Meanwhile, in the following description, for explanation, numerous specific details are set forth to provide a thorough understanding of the embodiments of the present disclosure. However, it will be obvious to those skilled in the art that the present disclosure may be practiced without the specific details herein or the specific ways described.

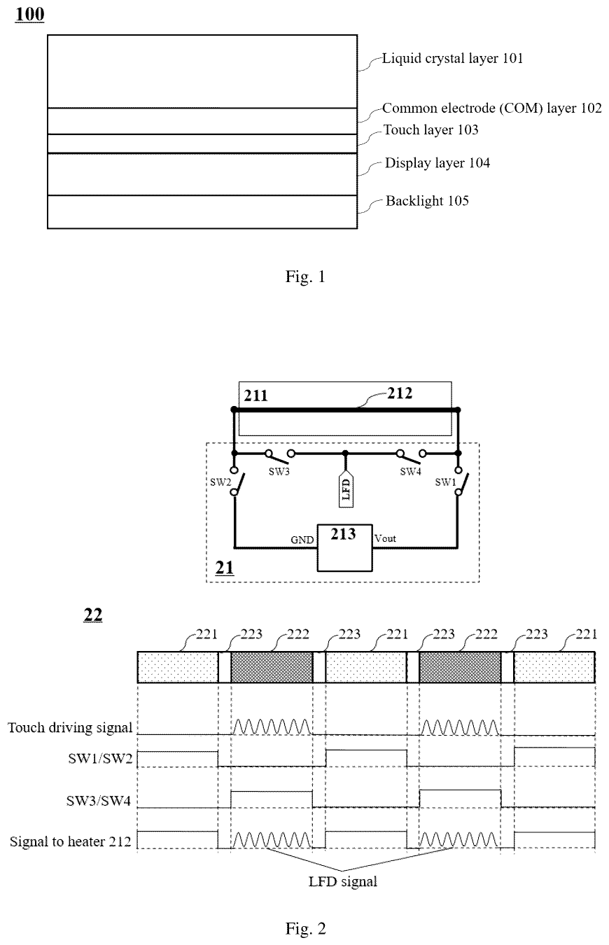

FIG. 1 shows a simplified schematic diagram of a liquid crystal display (LCD) display system 100. As shown in FIG. 1, an LCD display system may include a liquid crystal layer 101, a common electrode (COM) layer 102, a touch layer 103, a display layer 104, and a backlight 105, where the liquid crystal layer 101, the common electrode (COM) layer 102, the touch layer 103, and the display layer 104 may be integrated in a display panel as internal components thereof. Usually when LCDs are used in low-temperature environments, the response speed of the liquid crystal material will be significantly reduced, thereby affecting the response performance and display effect of the display. To solve this problem, a heater (not shown) may be provided below the display panel to maintain the operating of the display panel at a preferred temperature. In one example, the heater used to heat the display panel may, for example, be in the form of an impedance wire, but the present disclosure does not limit the specific form of the heater.

In order to reduce the overall thickness of the LCD display system, it may be considered to integrate the heater inside the display panel. For example, continuing to refer to FIG. 1, when integrating the heater into the display panel, as an example, the heater may be disposed below the COM layer 102 so as to be arranged in the same layer as the touch layer 103 or the display layer 104. However, this architecture that integrates the heater inside the display panel will form parasitic capacitance between the heater and the internal lines of the display panel (for example, data lines, gate lines, COM lines, touch signal lines, etc.), thereby affecting display or touch functions.

Considering that the touch function may be easily affected by the parasitic capacitance caused by the heater and thus be abnormal, in an embodiment according to the present disclosure, a signal with a fixed potential for performing the heating operation is applied to the heater during the display periods, and a loading free driving (LFD) signal for reducing or eliminating the influence of parasitic capacitance is applied to the heater during the touch periods, thereby reducing the impact of parasitic capacitance load on the touch function.

FIG. 2 shows an example of a heater driving circuit 21 and a signal timing diagram 22 according to an embodiment of the present disclosure, in which the heater driving circuit 21 can be used to apply a specific signal to a heater 212 inside a display panel 211. As mentioned before, as an example, the heater 212 may be disposed below the COM layer of the display panel so as to be arranged in the same layer as the touch layer or the display layer.

Referring to FIG. 2, the heater driving circuit 21 may include a power supply 213 and switches SW1, SW2, SW3, and SW4, where on and off operations of the switches SW1 to SW4 may be controlled by a touch and display driving integrated circuit (not shown) to control the heater driving circuit 21 to apply a specific signal to the heater 212. In one example, the power supply 213 may be a Low Dropout Regulator (LDO), but the present disclosure does not limit to this.

It should be noted that the circuit structure of the heater driving circuit 21 shown in FIG. 2 is only an example, and other forms of circuit structures may be used to implement the heater driving circuit according to embodiments of the present disclosure (for example, it may include other components or more/fewer components), and the present disclosure does not limit to this. For example, in another example of the heater driving circuit 21, the switches SW3 and SW4 may be replaced with a capacitor respectively, so that the application of a loading free driving (LFD) signal to the heater can be achieved through capacitive coupling.

Further referring to the signal timing diagram 22 in FIG. 2, in this example, an operation period of the display panel 211 may include a display period 221 for performing a display operation and a touch period 222 for performing a touch operation, where the display period 221 and the touch period 222 do not overlap with each other. In the display period 221, a high-level signal may be applied to the control terminals of the switches SW1 and SW2 so that the switches SW1 and SW2 are turned on, and a low-level signal may be applied to the control terminals of the switches SW3 and SW4 so that the switches SW3 and SW4 are turned off, thereby applying a signal with a fixed potential to the heater 212 through the power supply 213 to perform a heating operation. On the contrary, during the touch period 222, a low-level signal may be applied to the control terminals of the switches SW1 and SW2 so that the switches SW1 and SW2 are turned off, and a high-level signal may be applied to the control terminals of the switches SW3 and SW4 so that the switches SW3 and SW4 are turned on, thereby applying a loading free driving (LFD) signal to the heater 212 to perform a loading free driving operation. To achieve this, at least one of the waveform, frequency and phase of the LFD signal and the touch driving signal of the display panel may be the same, thereby reducing the impact of the capacitive load on the touch function.

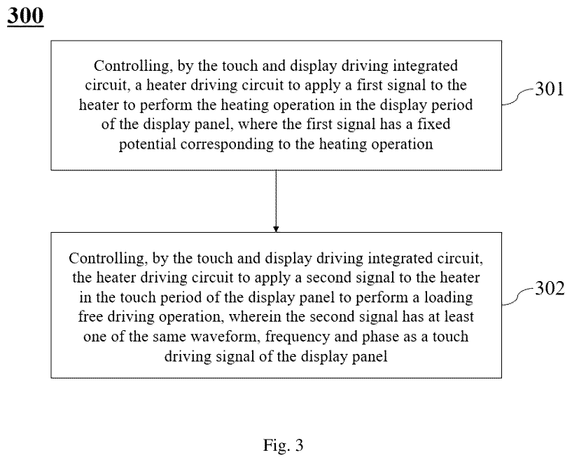

FIG. 3 shows a heating control method 300 for a display panel according to an embodiment of the present disclosure, where the display panel may include a heater for performing a heating operation, and the display period and the touch period of the display panel do not overlap with each other. As mentioned above, the heating control method 300 may be performed by the touch and display driving integrated circuit, which may apply a specific signal to the heater by controlling the heater driving circuit.

As shown in FIG. 3, in step S301, the touch and display driving integrated circuit controls the heater driving circuit to apply a first signal to the heater to perform the heating operation in the display period of the display panel, where the first signal has a fixed potential corresponding to the heating operation. Referring back to FIG. 2, the heater driving circuit in this step may be implemented, for example, by the heater driving circuit 21 shown in FIG. 2. As described above, as an example, the touch and display driving integrated circuit may control the switches SW1 and SW2 to be in the on state and the switches SW3 and SW4 to be in the off state during the display period 221, thereby applying the first signal with a fixed potential to the heater 212 through the power supply 213 to perform the heating operation.

In step S302, the touch and display driving integrated circuit controls the heater driving circuit to apply a second signal to the heater in the touch period of the display panel to perform a loading free driving operation, wherein the second signal has at least one of the same waveform, frequency and phase as a touch driving signal of the display panel. Similarly, continuing to refer back to FIG. 2, as an example, the touch and display driving integrated circuit may control the switches SW1 and SW2 to be in the off state and the switches SW3 and SW4 to be in the on state during the touch period 222, thereby applying the second signal as the LFD signal.

It should be noted that in specific applications, the touch driving signal may have different waveforms such as square wave, sine wave, triangle wave, etc. Accordingly, the waveform of the LFD signal shown in FIG. 2 is only an example, and the specific waveform of the second signal as the LFD signal may differ according to the specific form of the touch driving signal.

As such, in the heating control method for the display panel according to an embodiment of the present disclosure, the signal with a fixed potential for performing the heating operation is applied to the heater during the display period, while the LFD signal with the same waveform, frequency and/or phase as the touch driving signal is applied to the heater during the touch period, thereby reducing the impact of parasitic capacitive loads on the touch function.

In one example, in addition to having the same waveform, frequency and phase as the touch driving signal, the second signal according to an embodiment of the present disclosure may further have the same signal amplitude as the touch driving signal. That is, the second signal according to the embodiment of the present disclosure may be exactly the same signal as the touch driving signal.

Referring back to FIG. 2, in one example, an idle period 223 may also be included between adjacent display period 221 and touch period 222 serving as a separation therebetween. Accordingly, during the idle period 223, no signal may be applied to the heater 212.

In this example, in order to achieve that the potential on the heater can be quickly reduced to zero after stopping applying the signal with the fixed potential so as to facilitate further application of the LFD signal, optionally, when transitioning from the display period to the idle period, the touch and display driving integrated circuit may control the heater driving circuit to stop applying the first signal to a first terminal of the heater, and maintain the application of a ground signal to a second terminal of the heater until a predetermined time. For example, continuing to refer to FIG. 2, when transitioning from the display period 221 to the idle time 223, the touch and display driving integrated circuit may control the switch SW1 to turn off, thereby stopping applying the first signal from the Vₒᵤₜ terminal of the power supply 213 to the first terminal of the heater, and maintain the switch SW2 in the on state temporarily, thereby maintaining the application of the ground signal from the GND terminal of the power supply 213 to the second terminal of the heater until a predetermined time. In this example, the duration of the predetermined time may be less than or equal to the duration of a single idle period.

In the above embodiment, in order to further effectively control the heating operation of the heater, the temperature of the display panel may be compared with a predetermined temperature threshold, thereby determining whether to apply the first signal for performing the heating operation to the heater in the display period according to the comparison result.

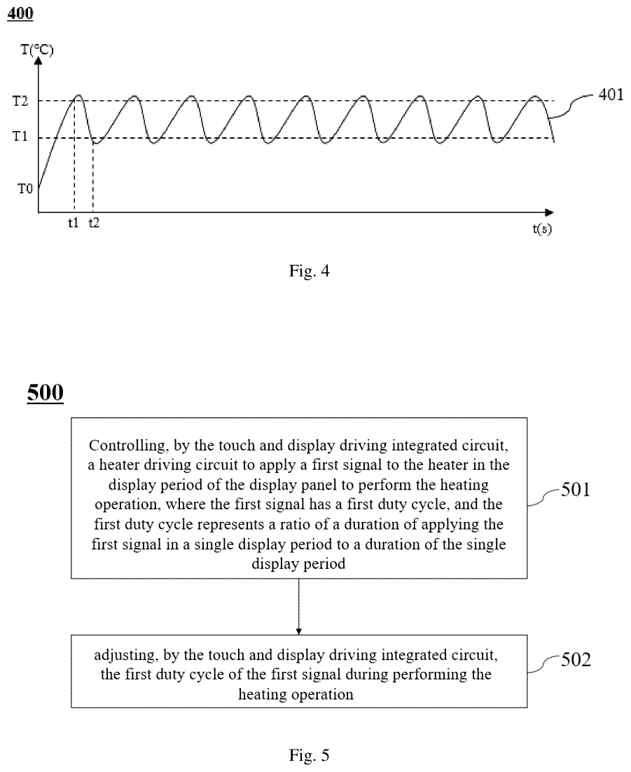

FIG. 4 shows a display panel temperature-time example 400 of a heating control method for a display panel according to an embodiment of the present disclosure, in which a curve 401 shows a change in a temperature T of a display panel (in degrees Celsius) over time during the heating operation of the heater according to the heating control method described below. Specifically, referring to FIG. 4, in one example, before performing the heating operation, the touch and display driving integrated circuit may compare the initial temperature T0 of the display panel with a first preset lower temperature limit value T1, and when the temperature T0 of the display panel is lower than the first preset lower temperature limit value T1, the touch and display driving integrated circuit controls the heater driving circuit to apply the first signal to the heater continuously in the display period of the display panel to perform the heating operation. As such, the heater may be activated to perform the heating operation when the temperature of the display panel is low, but not to perform the heating operation when the temperature of the display panel is high.

In order to enable the temperature of the display panel to gradually stabilize at a desired temperature interval and avoid overheating damage, continuing to refer to FIG. 4, in this example, during the heating operation, the touch and display driving integrated circuit may compare the temperature T of the display panel with a second preset upper temperature limit value T2, and when the temperature T of the display panel is higher than the second preset upper temperature limit value T2 (for example, at time t1 in FIG. 4), the touch and display driving integrated circuit may control the heater driving circuit to stop applying the first signal to the heater in the display period of the display panel; and after stopping applying the first signal to the heater, the touch and display driving integrated circuit may compare the temperature of the display panel with the first preset lower temperature limit value T1, and when the temperature T of the display panel is lower than the first preset lower temperature limit value T1 (for example, at time t2 in FIG. 4), the touch and display driving integrated circuit may control the heater driving circuit to apply the first signal to the heater in the display period of the display panel continuously. In this example, during the heating operation, the touch and display driving integrated circuit may periodically repeat the above process, thereby always stopping the heating operation of the heater when the temperature T of the display panel is higher than the second preset upper temperature limit value T2, and restarting the heating operation of the heater when the temperature T of the display panel is lower than the first preset lower temperature limit value T1, thereby realizing the control of the temperature T of the display panel within the temperature interval between T1 and T2, as shown in FIG. 4.

In the above example, the temperature variation range of the display panel can be controlled by adjusting the values of T1 and T2. For example, the temperature of the display panel can be made more stable by narrowing the difference between T1 and T2.

In another embodiment according to the present disclosure described below, it is possible to stabilize the temperature of the display panel by controlling the duty cycle of the first signal applied to the heater while avoiding the system from frequently performing the on and off switching setting operation for the heater.

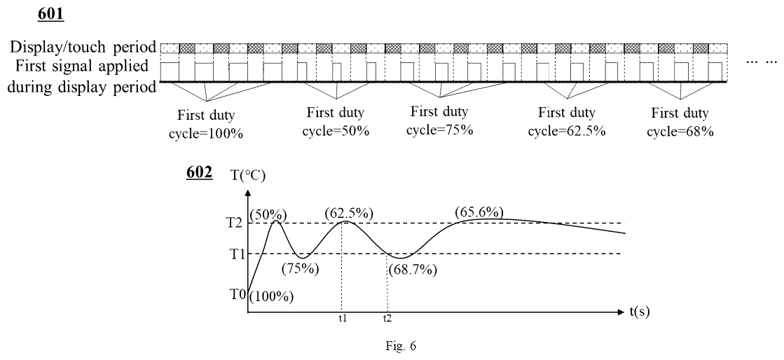

FIG. 5 shows a heating control method 500 for a display panel according to an embodiment of the present disclosure, where the display panel may include a heater for performing a heating operation, and the display period and the touch period of the display panel do not overlap with each other. As mentioned previously, the heating control method 500 may be performed by a touch and display driving integrated circuit, which may apply a specific signal to the heater by controlling a heater driving circuit (such as the heater driving circuit 201 shown in FIG. 2).

In step S501, the touch and display driving integrated circuit controls the heater driving circuit to apply a first signal to the heater in the display period of the display panel to perform the heating operation, wherein the first signal has a first duty cycle, and the first duty cycle represents a ratio of a duration of applying the first signal in a single display period to a duration of the single display period. That is, the first duty cycle may represent the ratio of the duration that the signal with the fixed potential corresponding to the heating operation is applied to the heater within a single display period to the length of the single display period.

In step S502, the first duty cycle of the first signal is adjusted by the touch and display driving integrated circuit during performing the heating operation.

That is, in this embodiment, during the heating operation, the temperature of the display panel is controlled by dynamically adjusting the duty cycle of the first signal applied to the heater in each display period while avoiding the system from frequently performing the on and off switching setting operation for the heater.

In one example, the temperature of the display panel may be compared with a first preset lower temperature limit value and a second preset upper temperature limit value by the touch and display driving integrated circuit during performing the heating operation; and, when the temperature of the display panel is lower than the first preset lower temperature limit value or higher than the second preset upper temperature limit value, the touch and display driving integrated circuit may adjust the first duty cycle of the first signal. More specifically, when the temperature of the display panel is lower than the first preset lower temperature limit value, the touch and display driving integrated circuit may increase the first duty cycle of the first signal; and, when the temperature of the display panel is higher than the second preset upper temperature limit value, the touch and display driving integrated circuit may reduce the first duty cycle of the first signal. That is, during the heating process, the temperature of the display panel may be continuously and periodically monitored and compared with the temperature threshold. When it is determined that the temperature of the display panel is too low, the first duty cycle may be increased to correspondingly increase the heating time of the heater. On the contrary, when it is determined that the temperature of the display panel is too high, the first duty cycle may be reduced to correspondingly reduce the heating time of the heater.

FIG. 6 shows an adjustment example 601 of a first duty cycle of a first signal and a corresponding display panel temperature-time example 602 according to an embodiment of the present disclosure. As shown in FIG. 6, the heating operation of the heater is first started based on a first duty cycle of 100%. During the heating operation, the temperature of the display panel is continuously compared with the first preset lower temperature limit value T1 and the second preset upper temperature limit value T2, and the first duty cycle of the first signal is continuously adjusted through “binary search”. For a specific example, referring to FIG. 6, assuming that it is determined at time t1 that the temperature T of the display panel is higher than the second preset upper temperature limit value T2, the first duty cycle can be changed from 75% to (50%+75%)/2=62.5%. For another example, assuming that it is determined at time t2 that the temperature T of the display panel is lower than the first preset lower temperature limit value T1, the first duty cycle can be changed from 62.5% to (75%+62.5%)/2=68.7%.

It should be noted that the adjustment example 601 of the first duty cycle of the first signal and the display panel temperature-time example 602 shown in FIG. 6 are only a possible example, and other adjustment examples of the first duty cycle of the first signal according to embodiments of the present disclosure are also within the scope of the present disclosure. For example, after reducing the first duty cycle from 75% to 62.5% at time t1, the temperature of the display panel may still continue to rise. Correspondingly, when the temperature of the display panel is subsequently compared with the threshold value and it is determined that the temperature of the display panel is still higher than the second preset upper temperature limit value T2, the heating time of the heater can be reduced by continuing to reduce the first duty cycle of the first signal.

In addition, although the example shown in FIG. 6 shows how to adjust the specific value of the first duty cycle of the first signal by “binary search”, the present disclosure is not limited to this, and other algorithms may be used to determine how to dynamically adjust the specific value of the first duty cycle of the first signal so that the temperature of the display panel continues to stabilize.

In yet another embodiment according to the present disclosure described below, the temperature of the display panel may be stabilized by controlling the number of display periods in which the first signal is applied among a plurality of consecutive display periods.

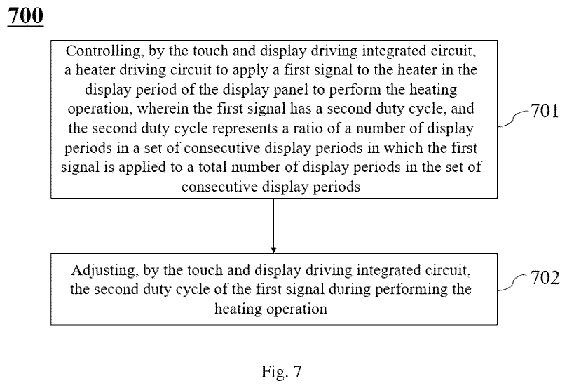

FIG. 7 shows a heating control method 700 for a display panel according to an embodiment of the present disclosure, where the display panel may include a heater for performing a heating operation, and the display period and the touch period of the display panel do not overlap with each other. As mentioned above, the heating control method 700 may be performed by the touch and display driving integrated circuit, which may apply a specific signal to the heater by controlling the heater driving circuit (such as the heater driving circuit 201 shown in FIG. 2).

In step S701, the touch and display driving integrated circuit controls the heater driving circuit to apply a first signal to the heater in the display period of the display panel to perform the heating operation, wherein the first signal has a second duty cycle, and the second duty cycle represents a ratio of a number of display periods in a set of consecutive display periods in which the first signal is applied to a total number of display periods in the set of consecutive display periods. For example, assuming that there are a total of 10 display periods in the set of consecutive display periods and the number of display periods in which the first signal is applied is 5, the second duty cycle is 5/10=50%. In one example, the display periods in which the first signal is applied in the set of consecutive display periods may be consecutive or discontinuous with each other, and the present disclosure does not limit to it.

In this step, optionally, the display periods in which the first signal is applied may have a first duty cycle of 100%. As mentioned before, the first duty cycle represents a ratio of a duration of applying the first signal in a single display period to a duration of the single display period. By applying the first duty cycle of 100% in the display period when the first signal is applied, the visual horizontal bright line (H-Line) problem caused by on and off switching of the heating operation during the display process can be avoided.

In step S702, the touch and display driving integrated circuit adjusts the second duty cycle of the first signal during performing the heating operation.

In one example, during the heating operation, the touch and display driving integrated circuit may compare the temperature of the display panel with a first preset lower temperature limit value and a second preset upper temperature limit value, and when the temperature of the display panel is lower than the first preset lower temperature limit value or higher than the second preset upper temperature limit value, the touch and display driving integrated circuit may adjust the second duty cycle of the first signal. More specifically, when the temperature of the display panel is lower than the first preset lower temperature limit value, the touch and display driving integrated circuit may increase the second duty cycle of the first signal; and, when the temperature of the display panel is higher than the second preset upper temperature limit value, the touch and display driving integrated circuit may reduce the second duty cycle of the first signal. That is, during the heating process, the temperature of the display panel can be continuously and periodically monitored and compared with the temperature threshold. When it is determined that the temperature of the display panel is too low, the second duty cycle can be increased to correspondingly increase the heating time of the heater. On the contrary, when it is determined that the temperature of the display panel is too high, the second duty cycle can be reduced to correspondingly reduce the heating time of the heater.

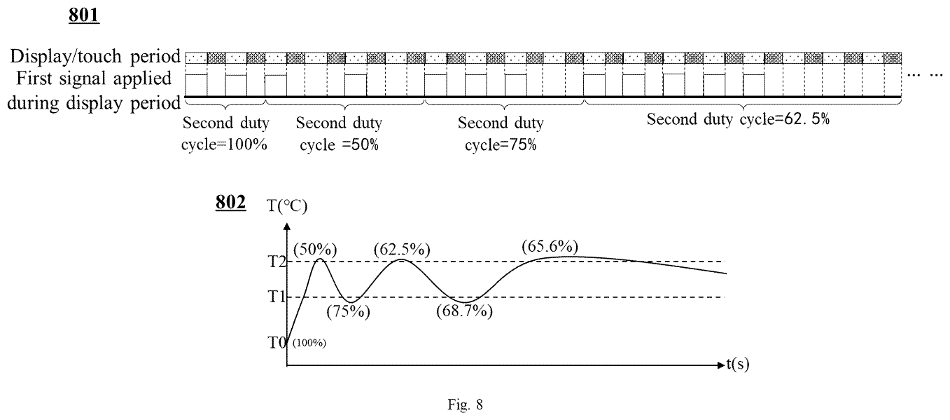

FIG. 8 shows an adjustment example 801 of a second duty cycle of a first signal and a corresponding display panel temperature-time example 802 according to an embodiment of the present disclosure. As shown in FIG. 8, the heating operation of the heater is first started based on a second duty cycle of 100%, where the first signal is applied in each of two consecutive display periods, so that at this time the second duty cycle is 100%. During the heating operation, the temperature of the display panel is continuously compared with the first preset lower temperature limit value T1 and the second preset upper temperature limit value T2, thereby continuously adjusting the second duty cycle of the first signal through “binary search”. For example, referring again to FIG. 8, after the second duty cycle of 100%, the second duty cycle is adjusted by “binary search” to 100%/2=50%, where the first signal is applied in two display periods of a set of four consecutive display periods, so that at this time the second duty cycle is 2/4=50%. For another example, after the second duty cycle of 50%, the duty cycle is adjusted by “binary search” to (100%+50%)/2=75%, where the first signal is applied in three display periods of a set of four consecutive display periods, so that at this time the second duty cycle is 3/4 =75%. It should be noted that there may be a possible idle period between any two “consecutive display periods” in the present disclosure, which is not limited here.

In addition, it should be noted that the adjustment example 801 of the second duty cycle of the first signal and the display panel temperature-time example 802 shown in FIG. 8 are only a possible example, and other adjustment examples of the second duty cycle of the first signal according to embodiments of the present disclosure are also within the scope of the present disclosure. For example, after reducing the second duty cycle, the temperature of the display panel may still continue to rise. Correspondingly, after comparing the temperature of the display panel with the threshold value to determine that the temperature of the display panel is higher than the second preset upper temperature limit value T2 subsequently, the second duty cycle of the first signal can be continued to be reduced to reduce the heating time of the heater.

In addition, although in the example shown in FIG. 8, “binary search” is used to determine how to adjust the specific value of the second duty cycle of the first signal, the present disclosure is not limited to this, and other algorithms may be used to determine how to dynamically adjust the specific value of the second duty cycle of the first signal so that the temperature of the display panel continues to stabilize.

Below, a display system according to an embodiment of the present disclosure is described, which may include: a display panel; a heater in the display panel for performing a heating operation; a heater driving circuit; and a touch and display driving integrated circuit configured to perform the above-described various methods or steps according to embodiments of the present disclosure. The heater driving circuit may be implemented, for example, by the heater driving circuit 21 shown in FIG. 2, but the present disclosure is not limited thereto.

The basic principles of the present disclosure have been described above in connection with specific embodiments. It should be pointed out that the advantages, advantages, effects, etc. mentioned in the embodiments of the present disclosure are only examples rather than limitations, and these advantages, advantages, effects, etc. cannot be considered as necessary for all embodiments of the present disclosure. In addition, the specific details disclosed above are only for the purpose of illustration and easy understanding, but not for limitation, and the above details do not mean that the present disclosure must be realized with the above specific details. It should also be pointed out that in the device and method of the present disclosure, each component or step can be decomposed and/or recombined. These decompositions and/or recombination should be regarded as equivalent schemes of the present disclosure.

For ordinary operators in the field, it can be understood that all or any part of the method and device disclosed in the present disclosure can be implemented in hardware, firmware, software or their combination in any computing device (including processor, storage medium, etc.) or network of computing devices. The hardware may be a general-purpose processor, a digital signal processor (DSP), an application-specific integrated circuit (ASIC), a field programmable gate array signal (FPGA) or other programmable logic device (PLD), discrete gate or transistor logic, discrete hardware components, or any combination thereof designed to perform the functions described herein. A general-purpose processor may be a microprocessor, but alternatively, the processor may be any commercially available processor, controller, microcontroller or state machine. A processor may also be implemented as a combination of computing devices, such as a combination of a DSP and a microprocessor, a plurality of microprocessors, one or more microprocessors cooperating with a DSP core, or any other such configuration. Software can exist in any form of computer-readable tangible storage media. By way of example and not limitation, such computer-readable tangible storage media may include RAM, ROM, EEPROM, CD-ROM or other optical disk storage, magnetic disk storage or other magnetic storage devices or any other tangible media that can be used to carry or store desired program codes in the form of instructions or data structures and that can be accessed by a computer. As used herein, a disc includes a compact disc (CD), a laser disc, an optical disc, a digital versatile disc (DVD), a floppy disc and a Blu-ray disc.

The block diagrams of elements, components, equipment, devices and systems involved in the embodiments of the present disclosure are only illustrative examples and are not intended to require or imply that they must be connected, arranged and configured in the manner shown in the block diagram. As those skilled in the art will recognize, these elements, components, devices, devices and systems can be connected, arranged and configured in any way.

In addition, the claimed scope of the present disclosure is not limited to the specific aspects of the above-mentioned processing, machinery, manufacturing, composition, means, methods and actions of events. Components, means, methods or actions of processes, machines, manufacturing, and events that currently exist or are to be developed later can be utilized to perform basically the same functions or achieve basically the same results as those described herein.

In addition, words such as “including”, “containing”, “having” and so on are open words, which mean “including but not limited to” and can be used interchangeably with them. The terms “or” and “and” as used herein refer to the terms “and/or” and can be used interchangeably with them unless the context clearly indicates otherwise. The word “such as” used here refers to the phrase “such as but not limited to” and can be used interchangeably with it.

The above description of the disclosed aspects is provided to enable any operator in the art to make or use the present disclosure. Various modifications to these aspects will be obvious to those skilled in the art, and the general principles defined herein can be applied to other aspects without departing from the scope of the present disclosure. Therefore, the present disclosure is not intended to be limited to the aspects shown herein, but is to be accorded the widest scope consistent with the principles and novel features disclosed herein.

1. A heating control method for a display panel, wherein the display panel includes a heater for performing a heating operation, and a display period and a touch period of the display panel do not overlap with each other, the method being performed by a touch and display driving integrated circuit, comprising:
controlling, by the touch and display driving integrated circuit, a heater driving circuit to apply a first signal to the heater to perform the heating operation in the display period of the display panel, wherein the first signal has a fixed potential corresponding to the heating operation; and,
controlling, by the touch and display driving integrated circuit, the heater driving circuit to apply a second signal to the heater in the touch period of the display panel to perform a loading free driving operation, wherein the second signal has at least one of the same waveform, frequency and phase as a touch driving signal of the display panel.

2. The method of claim 1, wherein the second signal further has the same signal amplitude as the touch driving signal of the display panel.

3. The method of claim 1, further comprising:
before performing the heating operation, comparing, by the touch and display driving integrated circuit, an initial temperature of the display panel with a first preset lower temperature limit value, and when the temperature of the display panel is lower than the first preset lower temperature limit value, controlling, by the touch and display driving integrated circuit, the heater driving circuit to apply the first signal to the heater continuously in the display period of the display panel to perform the heating operation.

4. The method of claim 3, further comprising, during performing the heating operation:
comparing, by the touch and display driving integrated circuit, the temperature of the display panel with a second preset upper temperature limit value, and when the temperature of the display panel is higher than the second preset upper temperature limit value, controlling, by the touch and display driving integrated circuit, the heater driving circuit to stop applying the first signal to the heater in the display period of the display panel; and,
after stopping applying the first signal to the heater, comparing, by the touch and display driving integrated circuit, the temperature of the display panel with the first preset lower temperature limit value, and when the temperature of the display panel is lower than the first preset lower temperature limit value, controlling, by the touch and display driving integrated circuit, the heater driving circuit to apply the first signal to the heater in the display period of the display panel continuously.

5. The method of claim 1, wherein an idle period is included between adjacent display period and the touch period, and no signal is applied to the heater during the idle period.

6. The method of claim 5, wherein when transitioning from the display period to the idle period, controlling, by the touch and display driving integrated circuit, the heater driving circuit to stop applying the first signal to a first terminal of the heater and to maintain the application of a ground signal to a second terminal of the heater until a predetermined time.

7. A heating control method for a display panel, wherein the display panel includes a heater for performing a heating operation, and a display period and a touch period of the display panel do not overlap with each other, the method being performed by a touch and display driving integrated circuit, comprising:
controlling, by the touch and display driving integrated circuit, a heater driving circuit to apply a first signal to the heater in the display period of the display panel to perform the heating operation, wherein the first signal has a first duty cycle, and the first duty cycle represents a ratio of a duration of applying the first signal in a single display period to a duration of the single display period; and,
adjusting, by the touch and display driving integrated circuit, the first duty cycle of the first signal during performing the heating operation.

8. The method of claim 7, wherein adjusting, by the touch and display driving integrated circuit, the first duty cycle of the first signal during performing the heating operation comprises:
comparing, by the touch and display driving integrated circuit, the temperature of the display panel with a first preset lower temperature limit value and a second preset upper temperature limit value during performing the heating operation; and,
adjusting, by the touch and display driving integrated circuit, the first duty cycle of the first signal when the temperature of the display panel is lower than the first preset lower temperature limit value or higher than the second preset upper temperature limit value.

9. The method of claim 8, wherein adjusting, by the touch and display driving integrated circuit, the first duty cycle of the first signal when the temperature of the display panel is lower than the first preset lower temperature limit value or higher than the second preset upper temperature limit value comprises:
increasing, by the touch and display driving integrated circuit, the first duty cycle of the first signal when the temperature of the display panel is lower than the first preset lower temperature limit value; and,
reducing, by the touch and display driving integrated circuit, the first duty cycle of the first signal when the temperature of the display panel is higher than the second preset upper temperature limit value.

10. A heating control method for a display panel, wherein the display panel includes a heater for performing a heating operation, and a display period and a touch period of the display panel do not overlap with each other, the method being performed by a touch and display driving integrated circuit, comprising:
controlling, by the touch and display driving integrated circuit, a heater driving circuit to apply a first signal to the heater in the display period of the display panel to perform the heating operation, wherein the first signal has a second duty cycle, and the second duty cycle represents a ratio of a number of display periods in a set of consecutive display periods in which the first signal is applied to a total number of display periods in the set of consecutive display periods; and,
adjusting, by the touch and display driving integrated circuit, the second duty cycle of the first signal during performing the heating operation.

11. The method of claim 10, wherein adjusting, by the touch and display driving integrated circuit, the second duty cycle of the first signal during performing the heating operation comprises:
comparing, by the touch and display driving integrated circuit, the temperature of the display panel with a first preset lower temperature limit value and a second preset upper temperature limit value during performing the heating operation; and,
adjusting, by the touch and display driving integrated circuit, the second duty cycle of the first signal when the temperature of the display panel is lower than the first preset lower temperature limit value or higher than the second preset upper temperature limit value.

12. The method of claim 11, wherein adjusting, by the touch and display driving integrated circuit, the second duty cycle of the first signal when the temperature of the display panel is lower than the first preset lower temperature limit value or higher than the second preset upper temperature limit value comprises:
increasing, by the touch and display driving integrated circuit, the second duty cycle of the first signal when the temperature of the display panel is lower than the first preset lower temperature limit value; and,
reducing, by the touch and display driving integrated circuit, the second duty cycle of the first signal when the temperature of the display panel is higher than the second preset upper temperature limit value.

13. A display system, comprising:
a display panel;
a heater in the display panel for performing a heating operation;
a heater driving circuit; and
a touch and display driving integrated circuit, configured to perform the method according to claim 1.
